(19) United States
(12) Patent Application Publication
(10) Pub. No.: US 2016/0267471 A1
(43) Pub. Date: Sep. 15, 2016

(54) Payment system with distributed money supply and choice in currency

(71) Applicant: Svetoslav Lazarov Gramenov, Varna (BG)

(72) Inventor: Svetoslav Lazarov Gramenov, Varna (BG)

(21) Appl. No.: 14/656,746

(22) Filed: Mar. 13, 2015

(51) Int. Cl. G06Q 20/36; G06Q 20/38; G06Q 20/06

(52) U.S. Cl. CPC G06Q 20/363; G06Q 20/065; G06Q 20/389

(57) ABSTRACT

The invention provides a payment system which can be implemented in a web environment, where users are entitled to generate their own currency in a certain pattern. Digital wallets for the users are created and managed through a centralized server which acts as an intermediary in the currency generation, transactions and extinguishment. The currency units generated by the users compete with each other and with a centrally issued (reserve) currency, generated by the operator of the system. Each user is provided the option to create a personal filter for the payments he/she receives in the system based on one or more of the currency features. A money market where all units of currency can be traded is also provided in order to facilitate the value exchange in the system and measure the exchange rate of user generated currencies against the reserve currency and/or against other currencies.

### BACKGROUND

1. Field of Invention

The current disclosure relates generally to the operation of a payment system implemented in a web environment with a distributed money supply and choice in currency.

2. Description of the Related Art

Distributed money supply and choice in currency are concepts well known for decades. Many economists, the most famous of which is perhaps Friedrich Hayek, have studied the problems of traditional monetary systems and have pointed out that the monopoly exercised by governments and commercial banks is not healthy for the economy and a proper monetary system should present the option for those who participate in it to create their own money while others choose whether to accept it or not.

In the current monetary system the creation of money is a privilege primarily of private commercial banks who issue, through the process of fractional reserve lending, up to 97% of the money in circulation according to various researchers. Furthermore, the legal tender status of this money is enforced by laws and by the government, making it hard, sometimes even illegal, for participants in the monetary system to exchange goods and services through mediums of exchange other than the currency which has legal tender status.

There have been many alternatives to fiat money over time starting with complementary currencies in the form of paper notes, going through mutual credit schemes and time banks and recently developed various types of digital currency schemes. The problem with most such schemes is that each of them represents a separate monetary system, relatively narrow in scope. Rarely a multitude of currencies is integrated into a monetary system and let to circulate together as mediums of exchange.

Providing different participants in a monetary system with the option to generate money is also known as distributed money supply. A system with distributed money supply must also provide a choice in currency. This means that either no single currency unit has legal tender status or only a certain currency unit, possibly acting as a reserve currency, has such status while all other currencies don't. This may in some cases stall the exchange of goods and services through the system since various users may choose to accept various—not necessarily coinciding—currencies. One possible solution to such problem is the implementation of a money market. Different currencies in the system must not only be able to compete with each other but it must also be easy for users to trade/exchange them.

A monetary system with distributed money supply, choice in currency and a liquid currency market will be beneficial for its participants since it facilitates the exchange of goods and services among them. It will also contribute to a fair and equal wealth distribution since a monopoly on the money creation will no longer exist.

### SUMMARY

This section explains how the invention overcomes the problems pointed out in the background. A monetary system is presented with implemented methods for distributed money supply, choice in currency and a currency market.

The system can be implemented in a web environment wherein users interact with each other and an operator of the system through a network. Currencies in the system are all created in the same pattern: centrally stored and managed digital wallets which consist of accounts with different preferences such as whether the currency is created by the operator of the system or by a user, the goods and services offered by the issuer of the currency, market value of the currency, etc.

Choice in currency is implemented by providing users with the possibility to customize a filter for receiving payments. The filter sets minimum criteria for one or more of the currency features that have to be met in order for the user to receive a payment in the system. This is a choice in general. The user specifies what type of currencies she is ready to accept. A specific choice can also be made where the user selects the exact currencies which she is willing to accept.

A money market is also implemented where both parties in a transaction swap different types of currencies. The market operates under the rules of a common financial market with offers for buying and selling. These offers are used to determine the exchange rate of a certain currency against the reserve currency and/or against other currencies at each specific moment. This exchange rate forms the market price of the respective currency which is one of the features of money in the system.

A central server used for operating the system has access to the user accounts and filters and the money market. It manages the accounts by creating currency upon request by users and debiting and crediting respective accounts when a transaction is made. The server is also customized to determine if a transaction is possible between two users based on the wallet of the payer and the filters of the payee—and if not immediately possible, whether it would be possible after transactions in the money market and what options may exist for purchasing money acceptable to the payee.

### BRIEF DESCRIPTION OF DRAWINGS

FIG. 1 illustrates the basic interactions in the monetary system.

FIG. 2.1 illustrates a user wallet with multiple accounts.

FIG. 2.2 illustrates an exemplary user payments filter.

FIG. 3 illustrates the process of currency generation.

FIG. 4 illustrates the process of payment from the perspective of a user, acting as payer.

FIGS. 5.1, 5.2 and 5.3 illustrate the execution of a transaction by the server.

FIG. 6 illustrates the process of payment execution through the financial market.

FIG. 7 illustrates the functioning of the financial market in the system.

### DETAILED DESCRIPTION

An exemplary embodiment, as described below, may be used to provide a monetary system with distributed money supply and choice in currency.

Interaction within the System

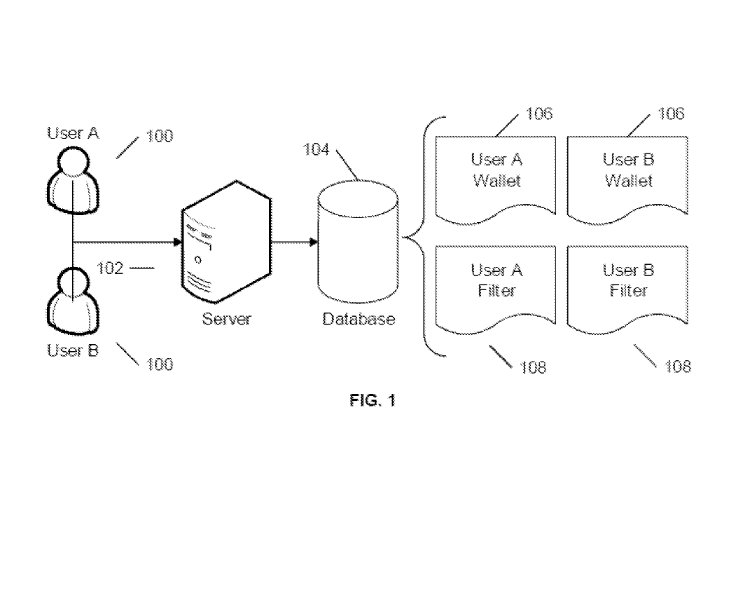

The participants in the monetary system and the way they interact with each other will be explained with reference to FIG. 1. Users (100) of the system interact with a server (102) or a multitude of servers which operate the system. The server (102) is coupled to a database (104) and is capable of storing and altering the data in the database. The database contains at least data for wallets (106) and payment filters (108) of the users. A wallet contains all accounts of a certain user and an account holds all of the currency units of a certain type owned by the said user. Different accounts contain different type of currency. The filter of the user contains settings set by the user for receiving payments in the monetary system. Both the wallet and the filter will be explained further below in the current description.

The users interact with each other and the server through a network, for example the Internet. However other types of networks can also support the server. Users connect to the network through various data processing devices. These processing devices may be personal computers, laptop computers, mobile phones, tablets, etc. The device must be capable of sending and receiving data through the network and visualize a user interface for interaction with the system. Software must be installed on the data processing devices in order for enabling them to display the interface and interact with other participants of the system.

The server (102) and the database (104) are also connected to the network. They may be put under the control of an operator of the system but can also be customized to function autonomously. The server records and retrieves data from the database in order to execute transactions between users.

The server is also capable of operating a market for the currency units in the system. The market facilitates the value exchange in the system with choice in currency by providing additional options for payment through a transaction chain. The functioning of the money market will also be explained further below.

### User Wallets

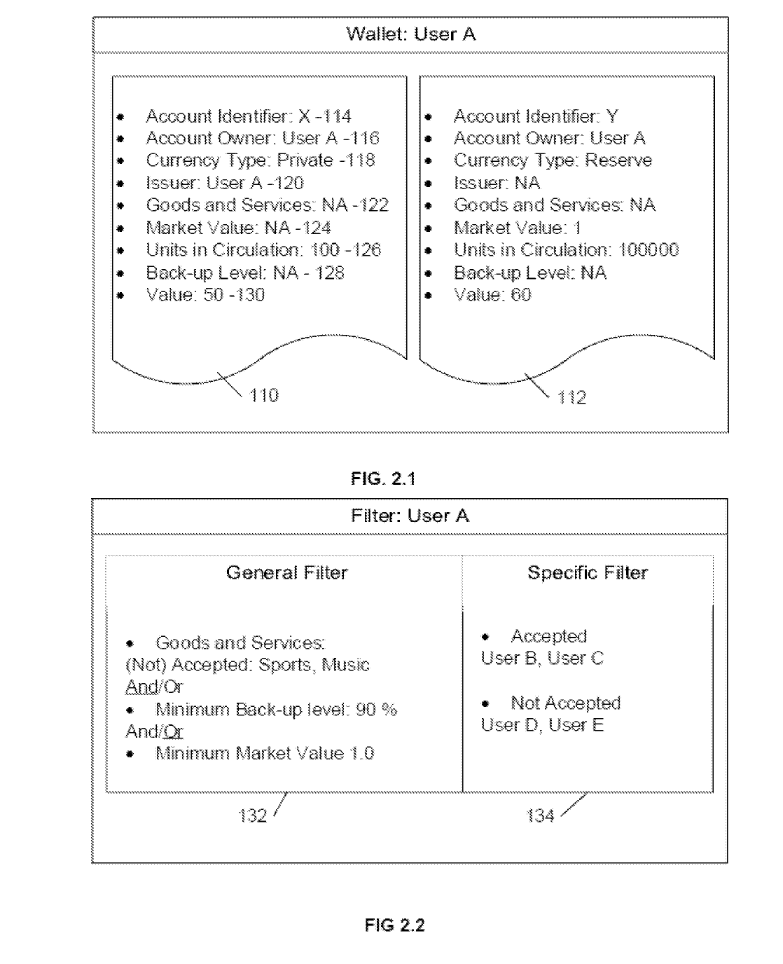

FIG. 2.1 depicts an exemplary user wallet. As mentioned above the wallet contains data for all accounts of a user. Each account contains different type of currency and preferably all the currency units of the same type are contained in the same user account. However it is possible to customize the system so that a wallet can contain different accounts with the same type of currency. Each account has a number of variables which identify it and define it. In the current description these variables will be referred to as parameters. The first parameter is the account identifier (114). This identifier is used for easy access and reference to the account. It may be a string of symbols like numbers or alphabetical characters. Every account has a unique identifier which is assigned to it by the server when it is created. The owner parameter (116) reflects the connection between the account, the wallet and the user. A user can only have one wallet and all accounts in the wallet are owned by the user who owns the wallet. This parameter is also set by the server when it creates an account in the wallet. The next parameter is the first main parameter of the currency—the currency type (118). There are two major types of currencies in the system—private and public. Private currencies are created by the users of the system on their own initiative while public currency is only one and is created centrally by the operator of the system and act as a reserve currency. The public currency can also be traded among the users. The issuer parameter (120) is only applicable to private currencies and refers to the user n whose initiative the currency has been created. Initially the value if this parameter is the same as the value of the owner parameter (116) since the issuer of the money is its first owner. The next parameter is indicates the business activity of the issuer and refers to the goods and services offered by him (122). These goods and services are preferably selected from taxonomy of goods and services in the system. Another parameter of the currency is its market value (124). The market value of a certain currency represents the exchange rate of this currency for the public currency. It is determined by the financial market through the process of price discovery. The units-in-circulation parameter (126) indicates the total amount of currency units issued. The back-up level parameter (128) can also be implemented in the system. It represents the value of the total amount of goods and services which the issuer can offer in a certain period of time in comparison with the currency in circulation issued by him. For example if the measurement period is one month and the issuer can offer goods and service worth 100 currency units through that month he can issue exactly 100 currency units which will have 100% back-up level. If the user has issued 200 currency units they will only have 50% back-up level since only half of it can be redeemed for goods and services of the issuer. In order for such parameter to be implemented users of the system who issue currency must be obligated to report the amount of goods and services they can offer over the set period of time and their value. The last parameter of the account is value parameter (130). It indicates the amount of currency units in the account. This parameter is increased or decreased upon transactions and issuance of currency. Two different accounts are depicted in FIG. 2.1. The first one (110) contains private currency and the other (112) contains reserve (public) currency. The public (reserve?) currency has no issuer, goods-and-services and services and back-up level parameters and its market value is expected to always be 1. The unlimited number of possible unique accounts represents the distributed money supply in the system.

### Payment Filters

FIG. 2.2 illustrates an exemplary filter customized by a user of the system. The filter represents the minimum conditions set by a user for the currencies he is willing to accept as payment in the system. There are two types of filters—a general filter (132) and a specific filter (134). The general filter uses the parameters of the accounts to set the preferences of the currencies which are capable of passing the filter. Various conditions or group of conditions can be set by the users and they may exist simultaneously or alternatively. In the current example the user has selected that he only wants to receive currency units which are issued by a user who offers goods and services that relate to sports and music. These currencies must also have either 90% back-up level or a market value of at least 1.0. The specific filter operates together with the general filter and adds exceptions to the common rules provided by the general filter. In the specific filter the user may either select users whose currencies he will not accept even if they cover the requirements of the general filter or the opposite—select users whose currencies he will accept even if they do not cover these requirements. The filters should preferably be customized to operate with various conditions or groups of conditions which depend on the currency parameters in the system. A user can only have one general filter but it can contain various alternative requirements. The customizable payment filters represent the choice in currency mechanism in the system.

Two possible exceptions can be set for the filters in the systems. The first one applies for the public currency. The system may be designed in a such a way that when transactions are executed with public currency it does not have to necessary cover the requirements set in the filters. This means that public money will have an enforced legal tender status in the system. The other exception applies to money issued by the payee. A user is obligated to accept as payment the currency units issued by him in the system. The money which is paid back to its issuer is also extinguished in the system rather than added to the account of the user. These exceptions can easily be implemented in the system and may facilitate the exchange of goods and service and balance the money supply.

In another aspect of the invention payment filters can be adjusted in a different manner. Users may be entitled to not only set minimum requirements for currency which they are willing to receive but also set acceptance at lower or higher value than the nominal value of the currency. For example if a user does not want to be paid in money issued by companies operating in a certain (oil, for example) industry he may exclude such money from the specific filter but he can also choose the option to accept the money at a lower value. If the user accepts money issued by companies in the oil industry at 0.5 of their nominal value, and a payer wants to pay 10 units of such currency to the user, the transaction will actually cost him 20 units of that currency. The opposite is also possible. A user may want to stimulate a specific industry or issuer of money by accepting the respective currency at higher value than its nominal one.

### Money Creation

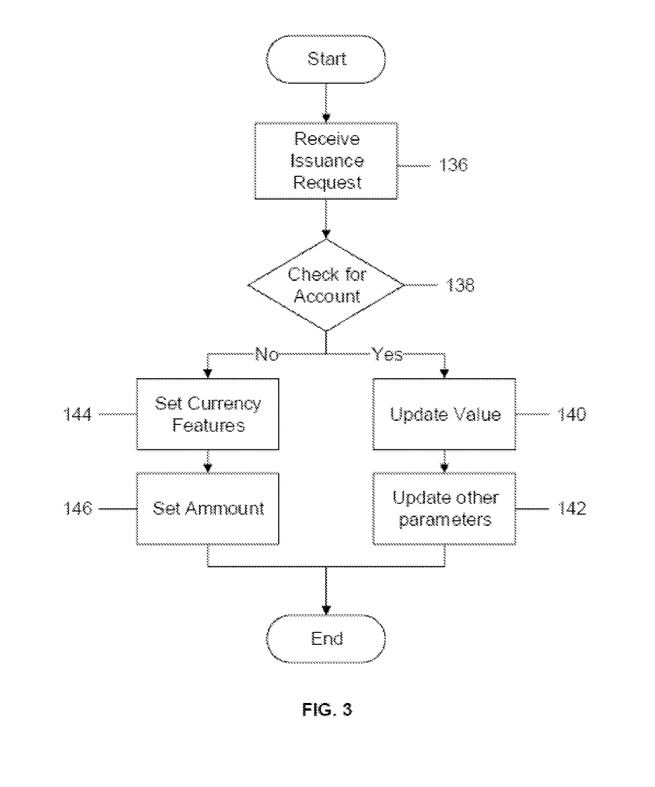

FIG. 3 further explains the distributed money supply in the monetary system. It represents the process of money issuance on the initiative of the users. The user must first send through his data processing device an issuance request to the server (136). The issuance request must only contain the amount of units that the user wants to create in his wallet. The server then checks if there is an existing account in the wallet of the user for money issued by him (138). If such account already exists the server increases the value with the amount of currency units in the request (140). The server then updates the other relevant parameters (142)—the total amount of currency units in circulation and the back-up level. An account for this type of currency will already exist in the wallet if the user has issued money before. If there is no such account the server must first create it by setting all the parameters (features of the currency) (144). The server automatically sets a unique identifier of the account. It also retrieves the user data to set the owner and issuer parameter and if the user has selected his business activity the goods-and-services parameter is also selected from taxonomy of goods and services. The back-up-level parameter will only be available of the user has reported commercial turnover data and the market value will be calculated by the server. The amount of currency units is then retrieved from the request sent by the user (146) and recorded as value of the corresponding parameter.

It is possible to implement issuance limits in the system. These limits will stop a user for issuing too much currency. They can be associated with the total amount of currency units in circulation or the back-up level of the currency. The limits should be set by the operator of the system and the server can be customized to check if these limits are reached or not.

Transactions from the Perspective of the Payer

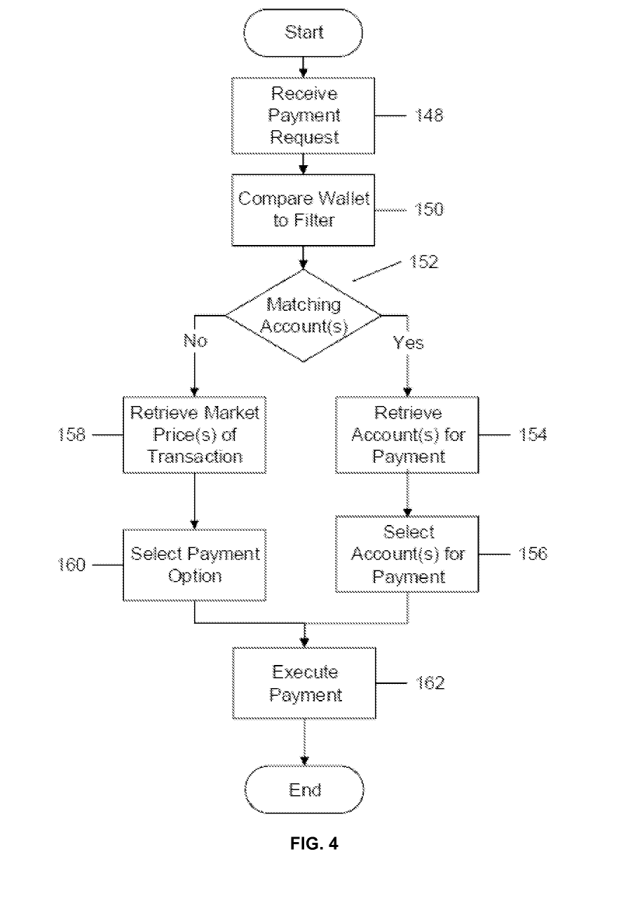

The transaction process will be explained from the perspective of a user acting as payer in the system and with reference to FIG. 4. The figure represents a flowchart of the transaction process. It starts with a payment request (148) sent by the payer to the server through the data processing device of the user. Once the request is received by the server it retrieves the payment filter conditions of the payee and compares them to the accounts in the wallet of the payer (150). If the wallet contains one or more accounts that cover the requirements of the payment filter (152) the server retrieves data from the accounts (154) and presents it to the payer who can select what amount of which accounts to use for the payment. For example if the payer wants to pay 50 units of currency and he has two accounts that cover the requirements of the payee he can choose to pay 50 units from either account or one part of the amount of the payment from the first account and the rest from the second.

If there is no account in the wallet of the user that covers the requirements of the payment filter the server than searches for options to execute the transaction form the money market. Executing a transaction through the money market involves another user or multiple users who have published offers in the money market. The server estimates different options for the payer to buy currency which can pass the payment filter. This is achieved through comparison of the accounts of the user with the offers in the money market. The server retrieves the prices of the options for transaction (158) and presents them to the user for selection (160). For example let's assume that the payer has only currency with back-up level of 50% and the payee only accepts currency with 100 back-up level. Another user has published an offer in the money market to buy 50% back-up level currency for 100% back-up level currency at a 0.5 exchange rate. If the payer wants to pay 10 currency units to the payee he must first buy 100% back-up level currency units from the market and they will cost him 20 of his own currency units. So in order to make a payment of 10 units the payer has to pay 20 units. If the payer agrees to the conditions of the payment the server executes the transaction (162) by altering the value parameters of the payer, the payee and the user who participates through the money market.

### Transaction Execution

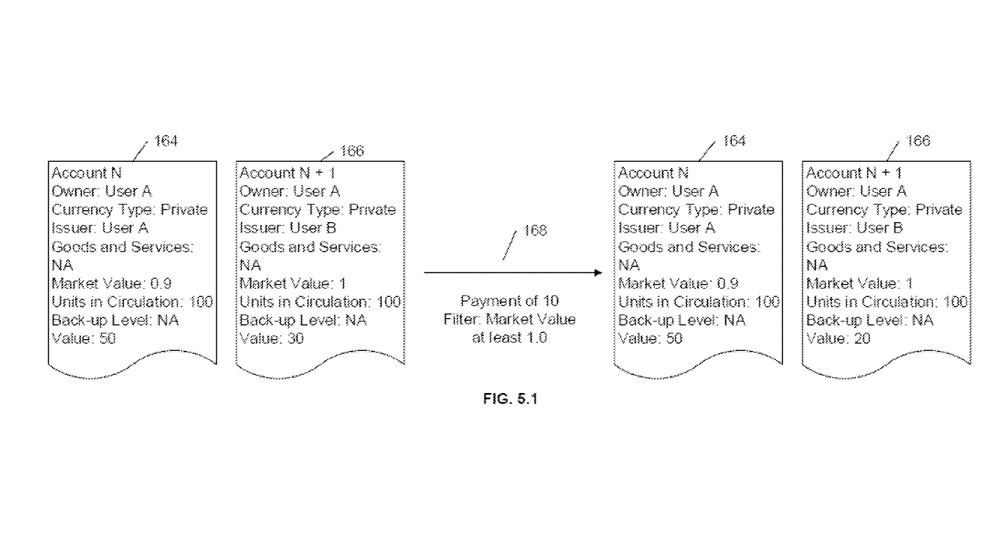

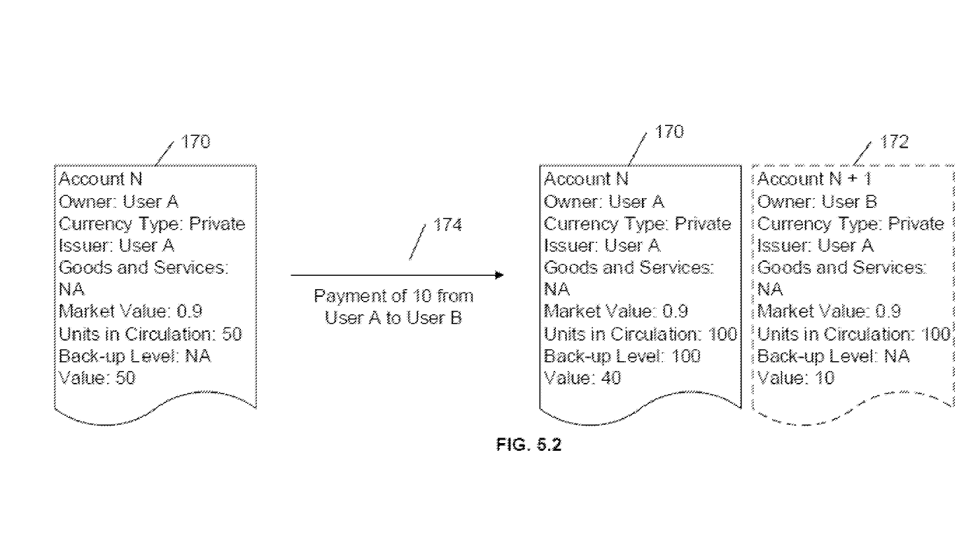

The transaction execution by the server will be explained with reference to FIG. 5.1, FIG. 5.2 and FIG. 5.3. FIG. 5.1 illustrates the transaction execution in the wallet of the payer. The wallet contains two accounts—account N (164) and account N+1 (166). Account N has a currency with market value of 0.9 and account N+1 has a currency with market value of 1.0. If the payer wants to make of 10 units and the payment filter only accepts currency with market value of at least 1.0 (168) the server will only decrease the value in the account with the higher market value since it is the only account that covers the requirements. The value parameter of account N+1 is thus decreased by 10.

FIG. 5.2 shows the dynamics in the accounts of both the payer and the payee. The payer pays 10 units (174) from his account (170) to the payee. The value parameter of the account of the payer is decreased by 10. Since the payee does not have an account with the currency he has received, the server creates an account almost identical to the one of the payer and only changes the identifier, the owner and the value parameters. The newly created account (172) has a value of 10 because it now contains 10 units of currency.

FIG. 5.3 illustrates a transaction executed through the money market. User A pays 10 units of currency with a 100% back-up level to user B after buying them from user C for 20 currency units with a back-up value of 50% (184). In order for the server to execute the transaction it must do the following: decrease the value parameter of the account of user A with 20 (176), decrease the value of the account of user C by 10 (178), create a new account in the wallet of user B with currency that has 100% back-up level and set the value to 10 (180), create a new account in the wallet of user C with currency that has 50% back-up level and set the value to 20 (182). This way 20 currency units with back-up level of 50% have been transferred to user C and 10 currency units with back-up level of 100% have been transferred to user A.

### Price of Transaction Through the Money Market

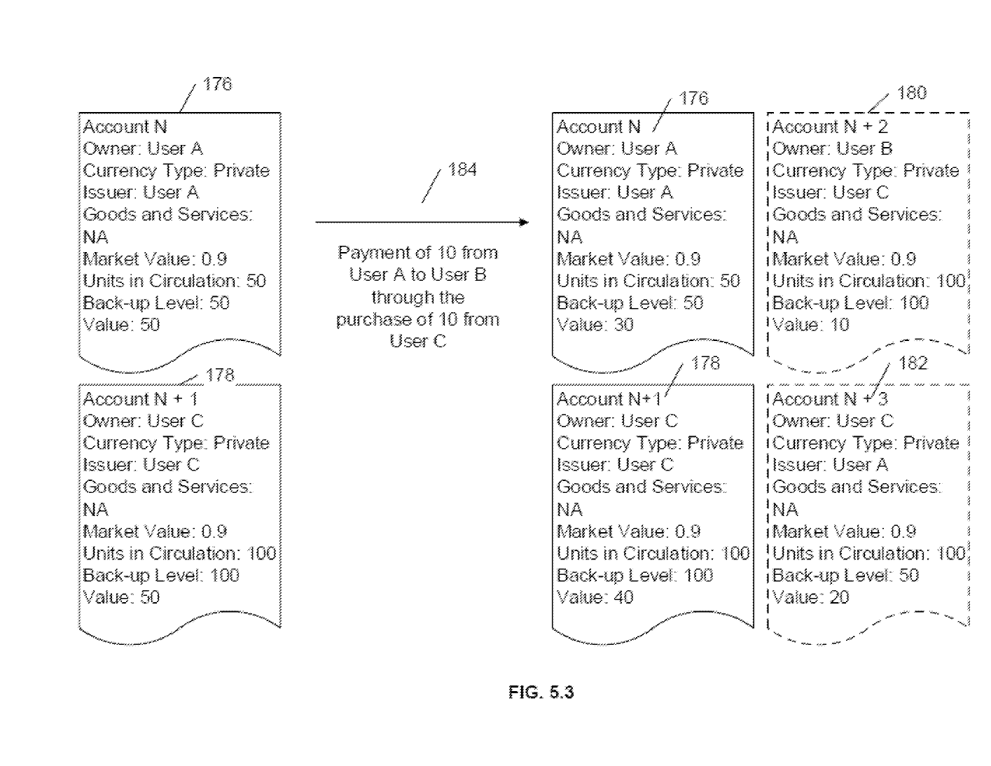

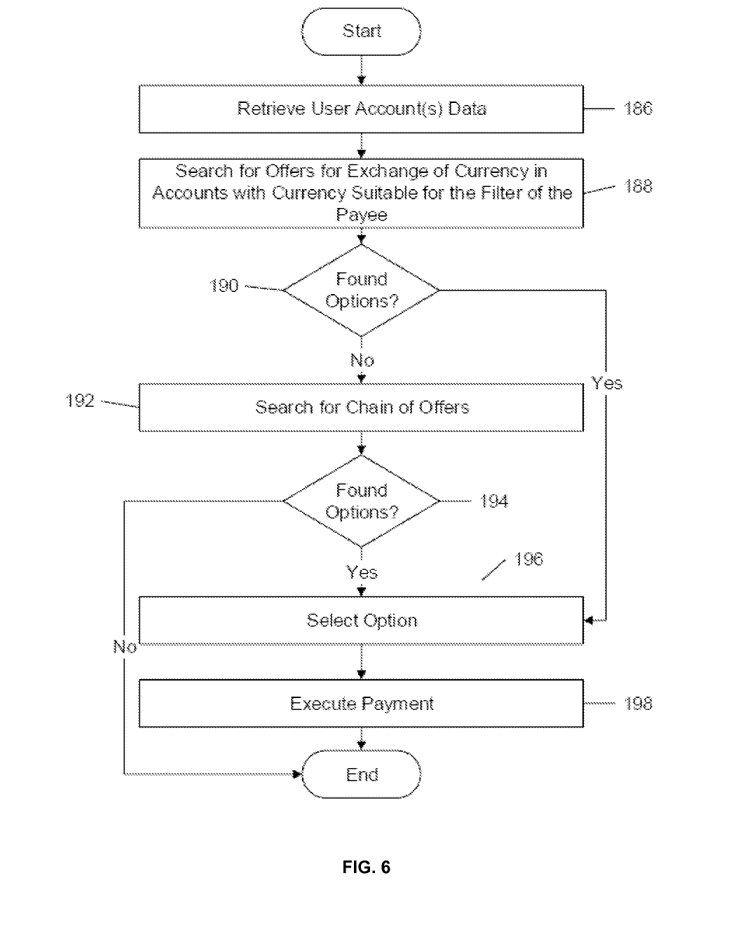

In order for a transaction to be executed through the money market, the server must be capable of searching for options to match the currency of the payer with the currency offered on the market that can pass the payment filter of the payee. This process is described with reference to FIG. 6. When the server has established that the user does not own enough currency to serve for the payment it retrieves the data for his accounts (186) and searches among all offers on the financial market for currency that can pass the filter. The server must then first check if it is possible to buy this currency with the currency of the payer (188). This means that only a single transaction will be necessary to obtain the currency needed for the payment. All available options (190) are presented to the payer for selection (196).

It is possible however that no options are found (190) for execution of the payment with just one transaction in the money market. The server will then further check if it is possible to obtain the currency for the payment with more than one transaction. (192) This means that the payer must first buy one currency from the money market and then use this currency to buy the currency which is capable of passing the payment filter of the payee. If such options are found (194) they are presented to the payer for selection (196). If an option is selected by the payer, the transaction is executed (198).

In another aspect of the invention the server may be customized to provide the payer with alternative options to make a payment through the money market even if he has currency, capable of passing the filter of the payee. For example if a user has set his filter to accept specific types of currency at a lower value than their nominal one it may be beneficial to first buy other type of currency from the money market and then use it for the payment.

### The Money Market

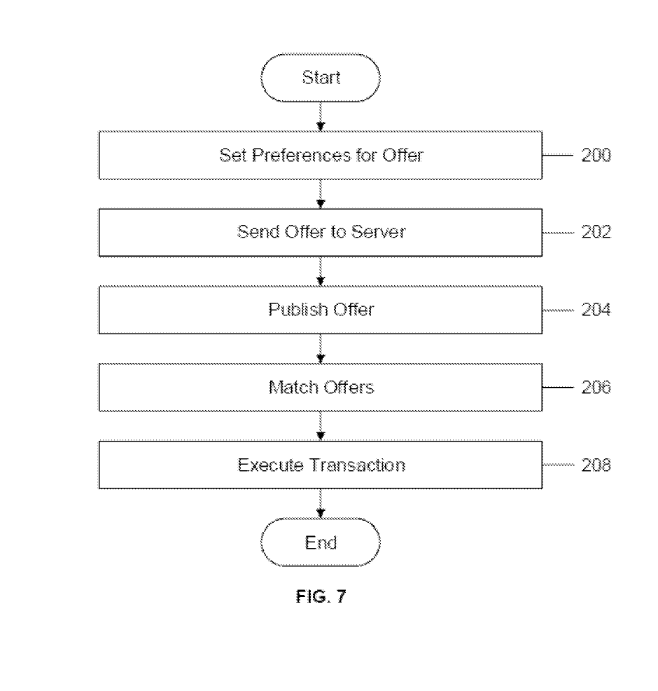

The basic method of functioning of the money market is illustrated in FIG. 7. Users of the system can trade the currencies in their accounts with other users through the server. The market operates with requests for offers which are sent to the server from the data processing devices of the users. For every offer the user must determine the following preferences (200): which currency from his wallet he wants to sell and what amount of it, what type of currency he wants to buy and exchange rate. This offer is sent to the server (202) and published on the money market (204). Publishing an offer on the money market means that it is made available for other users to see and that it can also be used for automatic transactions. When the server establishes matching offers (206) it automatically executes a transaction (208).

The present invention provides a monetary system with distributed money supply where users of the system are entitled to create their own currency in a certain pattern. Various types of currencies are possible through different parameters but they all have essentially the same structure and divisibility. In order for the monetary system to function with practically unlimited types of currency a choice in currency is provided to the users. Users make choice in currency by customizing their personal payment filters.

The system will make it easier for businesses to obtain their working capital since they will no longer have to rely on external financing. Currencies of successful businesses will naturally be preferred for exchange of value in the system. The system also allows users to show investment initiative through the financial market.

The invention can be customized to operate in various ways depending on the desired model of monetary and financial relations between users of the system. Both the money generation and the choice in currency can be limited in order to provide a stable system with no excessive money supply and controlled inflation processes. The option for choice in currency increases the users trust in the system and puts each individual user in control of his finances.

What is claimed is:

1. A method comprising:
1. providing, through terminal devices, a server or a multitude of servers and a database, coupled together through a network, a monetary system where each user has a digital wallet with accounts containing different types of currency;
2. the currency being generated through the server upon request of the users where each currency is created in separate account and in the same pattern and has specific features comprising:
(1) a string of characters serving as identifier;
(2) user associated data for the user who owns the currency;
(3) a reference to whether the currency has been created by the operator of the system or a user;
(4) user associated data for the user upon whose request the currency has been issued if applicable;
(5) goods and services offered by the issuer and level of back-up of the currency in circulation if applicable;
(6) exchange rate for the currency issued by the operator;
(7) total number of currency in circulation;
(8) parameter associated with the amount of currency units in the account;
3. executing transaction between the users in the system by altering the parameter associated with the amount of currency units of the respective accounts in the database;
4. enabling users to set payment filters through their data processing devices by specifying the type of currency which they are willing to accept;

2. The method of claim 1 where another type of currency, issued by an operator of the system, is introduced in the system;

3. The method of claim 2 where currency, issued by the operator of the system, can be transacted freely between the users regardless of any payment filters.

4. The method of claim 1 where currency issued by the payee can be transacted to the payee regardless of any payment filters.

5. The method of claim 1 where users are entitled to publish offers for buying and selling specific currencies, the published offers forming a money market for all currencies in the system.

6. The method of claim 2 where the information in the money market is used to provide a payer with options for buying currency which capable of passing a specific payment filter.

7. The method of claim 1 where the goods and services offered by the issuer of the currency are selected from taxonomy of goods and services integrated in the system;

8. The method of claim 1 where issuers of currency report data for goods and services available to be redeemed for currency issued by them over a certain period of time;

9. The method of claim 8 where the data provided by the issuers of the currency is used to determine a back-up level of the currency issued by a certain user associated with the total amount of currency units in circulation and the goods and services of the issuer that the currency can be redeemed for over a certain period of time.

10. The method of claim 1 where users can customize their payment filters to accept certain types of currencies at a value different than their nominal value.

11. A monetary system comprising:
1. a plurality of data processing devices, capable of sending and receiving data over a network and visualize an interface to interact with other users of the network;
2. a network, connecting all users of the monetary system;
3. a database for storing user wallets, containing accounts with specific types of currency and customizable minimum requirements for currencies, accepted by the respective user;
4. a server coupled through the network with the data processing devices of the users and the database, wherein the server is capable of manipulating upon request from a user the data stored in the database in order to create additional accounts for users and increase and decrease the account of currency units recorded in the account;
5. wherein the server is also capable of retrieving data about the accounts of a payer and the minimum requirements for acceptable currencies of the payee and establish if the payer has enough currency units capable of covering the requirements;

12. The system of claim 11 wherein users are entitled to send pending offers for buying and selling specific currencies, the offers been sent to the server and made available to the users of the system forming a money market for currencies where transactions are executed automatically by the server when a match in corresponding offers is established;

13. The system of claim 12 wherein the information in the money market is used to determine options for payers to buy with the currencies in their wallet currencies covering specific payment requirements
